(19) United States
(12) Patent Application Publication
(10) Pub. No.: US 2026/0296871 A1
(43) Pub. Date: Oct. 1, 2026

(54) BEVERAGE DISPENSER

(71) Applicant: Luckin Food Technology (Shanghai) Co., Ltd., Shanghai (CN)

(72) Inventors: Siyun Sun, Shanghai (CN); Xin Zhao, Shanghai (CN); Zhibin Zhu, Shanghai (CN); Yong Wu, Shanghai (CN)

(21) Appl. No.: 19/306,420

(22) Filed: Aug. 21, 2025

(30) Foreign Application Priority Data
Mar. 26, 2025 (CN) 202520539490.6

(51) Int. Cl. B67D 3/00; B01F 35/88; G01G 17/06

(52) U.S. Cl. CPC B67D 3/0003; B01F 35/881; G01G 17/06; B67D 3/0083

(57) ABSTRACT

Implementations of a beverage dispenser can include a reservoir containing a liquid, a dispensing system associated with the reservoir, the dispensing system including a weighted valve, a dispensing lever, and an actuator, and a control unit including a scanner operable to scan machine-readable codes, the control unit being operable to execute instructions stored in computer-readable memory to perform operations responsive to data determined from a machine-readable code, the operations including: operating the actuator for movement of the dispensing lever to one or more of move the weighted valve from a closed position to an opened position to dispense amounts of the liquid through the weighted valve, and move the weighted valve from an opened position to a closed position to cease liquid dispensing.

### CROSS-REFERENCE TO RELATED APPLICATION

This application claims the benefit of and priority to CN 202520539490.6, filed on Mar. 26, 2025, and entitled Beverage Dispenser, the disclosure of which is expressly incorporated herein by reference in the entirety for all purposes.

### TECHNICAL FIELD

The technology of this patent application relates to the technical field of beverage delivery equipment, and in particular to a beverage dispenser.

### BACKGROUND

Beverage dispensers enable a variety of beverages to be served to consumers. Enterprises that serve beverages to consumers use beverage dispensers in large traffic areas, for example, such as shopping malls, public transport stations, office buildings, and the like. Beverage stores often use beverage dispensers as material supply equipment and use beverage dispensers to hold different liquid beverage ingredients. In this manner, finished beverages can be made by selecting and combining different amounts of beverage ingredients.

Traditional beverage dispensers rely on an operator to estimate an amount of beverage or beverage ingredient to be dispensed from the beverage dispenser. For example, an operator can operate a switch to enable a flow of beverage or beverage ingredient and can discontinue the flow when an estimated amount has been dispensed. On the one hand, the amounts of beverage ingredients selected for beverages with different recipes is different. Consequently, it frequently occurs that the operator can confuse ingredients, mis-estimate amounts, and/or make other mistakes. Further, operating beverage dispensers occupies operator time that reduces work efficiency of operators.

### SUMMARY

Implementations of the present disclosure are generally directed to beverage dispensers. More particularly, implementations of the present disclosure are directed to a beverage dispenser that includes a first reservoir containing a first liquid, a first dispensing system associated with the first reservoir, the first dispensing system including a weighted valve, a dispensing lever, and an actuator, and a control unit including a scanner operable to scan machine-readable codes, the control unit being operable to execute instructions stored in computer-readable memory to perform operations responsive to data determined from a machine-readable code, the operations including: operating the actuator for movement of the dispensing lever to one or more of move the weighted valve from a closed position to an opened position to dispense amounts of the first liquid through the weighted valve, and move the weighted valve from an opened position to a closed position to cease liquid dispensing.

These and other implementations can each optionally include one or more of the following features: operations further include monitoring dispensing of amounts of the first liquid from the first reservoir, and determining that one of an actual amount of the first liquid dispensed from the first reservoir has achieved a stop amount and an estimated dispensing time has been met, and in response, operating the actuator of the first dispensing system for movement of the dispensing lever to move the weighted valve to a closed position to cease dispensing of the first liquid from the first reservoir; the beverage dispenser further includes a weighing system including a weighing sensor that generates a weight signal responsive to dispensing of the first liquid, the actual amount being determined based on the weight signal; the stop amount is determined as a difference between a target amount and an offset amount; the target amount is determined from the data determined from the machine-readable code; operations further include one of determining that a container has been placed to receive the first liquid dispensed from the first reservoir and, in response, actuating the actuator to commence dispensing of the first liquid from the first reservoir, and determining that a button associated with the first reservoir has been pressed and, in response, actuating the actuator to commence dispensing of the first liquid from the first reservoir; operations further include actuating the actuator to push a first end of the dispensing lever away from a housing of the beverage dispenser to move a second end of the dispensing lever against the weighted valve to move the weighted valve to the opened position; operations further include activating an indicator to indicate the first reservoir as to be used to dispense the first liquid from among a plurality of reservoirs; and the beverage dispenser further includes a second reservoir containing a second liquid and a second dispensing system associated with the second reservoir, wherein operations further include determining from second data determined from a second machine-readable code that a second liquid is to be dispensed from the second reservoir and, in response, activating an indicator to indicate the second reservoir as to be used to dispense the second liquid from among a plurality of reservoirs.

Implementations of the present disclosure are directed to a beverage dispenser that includes a plurality of reservoirs including a first reservoir containing a first liquid and a second reservoir containing a second liquid, a plurality of dispensing systems including a first dispensing system associated with the first reservoir and a second dispensing system associated with the second reservoir, and a control unit including a scanner operable to scan machine-readable codes, the control unit being operable to execute instructions stored in computer-readable memory to perform operations responsive to first data determined from a first machine-readable code, the operations including: operating a first actuator of the first dispensing system to move a first weighted valve from a closed position to an opened position to dispense amounts of the first liquid through the first weighted valve, and after ceasing dispensing of the first liquid, operating a second actuator of the second dispensing system to move a second weighted valve from the closed position to the opened position to dispense amounts of the second liquid through the second weighted valve.

These and other implementations can each optionally include one or more of the following features: the operations further include determining, from the first data, that a first target amount of the first liquid is to be dispensed from the first reservoir, monitoring dispensing of amounts of the first liquid from the first reservoir, and determining that one of an actual amount of the first liquid dispensed from the first reservoir has achieved a stop amount and an estimated dispensing time has been met, and in response, operating the first actuator of the first dispensing system for movement of a dispensing lever to move the first weighted valve to the closed position to cease dispensing of the first liquid from the first reservoir; operations further include determining, from the first data, that a second target amount of the second liquid is to be dispensed from the second reservoir; operations further include determining, from second data determined from a second machine-readable code, that a second target amount of the second liquid is to be dispensed from the second reservoir; the beverage dispenser further includes a weighing system including a weighing sensor that generates a weight signal responsive to dispensing of the first liquid, the actual amount being determined based on the weight signal; the beverage dispense further includes one or more of a boot disposed between the first actuator and a dispensing lever that acts on the first weighted valve, and a housing of the beverage dispenser that separates the first actuator and a dispensing lever that acts on the first weighted valve, the dispensing lever being located outside of the housing and the first actuator being located within the housing; the beverage dispenser further includes a cooling system that is operable to cool the first liquid within the first reservoir; the beverage dispenser further includes a temperature sensor that is responsive to a temperature of the first liquid within the first reservoir, the cooling system being operated responsive to the temperature; the beverage dispenser further includes one or more of a first button that is operable to manually dispense the first liquid from the first reservoir, and a second button that is operable to manually dispense the second liquid from the second reservoir; the first actuator of the first dispensing system is activated in response to input to the first button; the second actuator of the second dispensing system is activated in response to input to the second button; the operations further include activating a first indicator to indicate the first reservoir as to be used to dispense the first liquid; and the operations further include activating a second indicator to indicate the second reservoir as to be used to dispense the second liquid.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts a top perspective view of a beverage dispenser in accordance with implementations of the present disclosure.

FIG. 2 depicts an enlarged view of portion A depicted in FIG. 1.

FIG. 3 depicts an enlarged view of portion B depicted in FIG. 1.

FIG. 4 depicts a bottom perspective view of the beverage dispenser in accordance with implementations of the present disclosure.

FIG. 5 depicts a side view of the beverage dispenser in accordance with implementations of the present disclosure.

FIG. 6 depicts an enlarged view of portion C depicted in FIG. 5.

FIG. 7 depicts a bottom perspective view of the beverage dispenser in accordance with implementations of the present disclosure.

FIGS. 8-13 depict views of a beverage dispenser in accordance with implementations of the present disclosure.

FIG. 14 depicts a cross-sectional view of the beverage dispenser in accordance with implementations of the present disclosure.

FIG. 15 depicts an example process that can be executed in accordance with implementations of the present disclosure.

Like reference numbers and designations in the various drawings indicate like elements.

### DETAILED DESCRIPTION

Implementations of the present disclosure are generally directed to beverage dispensers. More particularly, implementations of the present disclosure are directed to a beverage dispenser that includes a reservoir containing a liquid, a dispensing system associated with the reservoir, the dispensing system including a weighted valve, a dispensing lever, and an actuator, and a control unit including a scanner operable to scan machine-readable codes, the control unit being operable to execute instructions stored in computer-readable memory to perform operations responsive to data determined from a machine-readable code, the operations including: operating the actuator for movement of the dispensing lever to one or more of move the weighted valve from a closed position to an opened position to dispense amounts of the liquid through the weighted valve, and move the weighted valve from an opened position to a closed position to cease liquid dispensing.

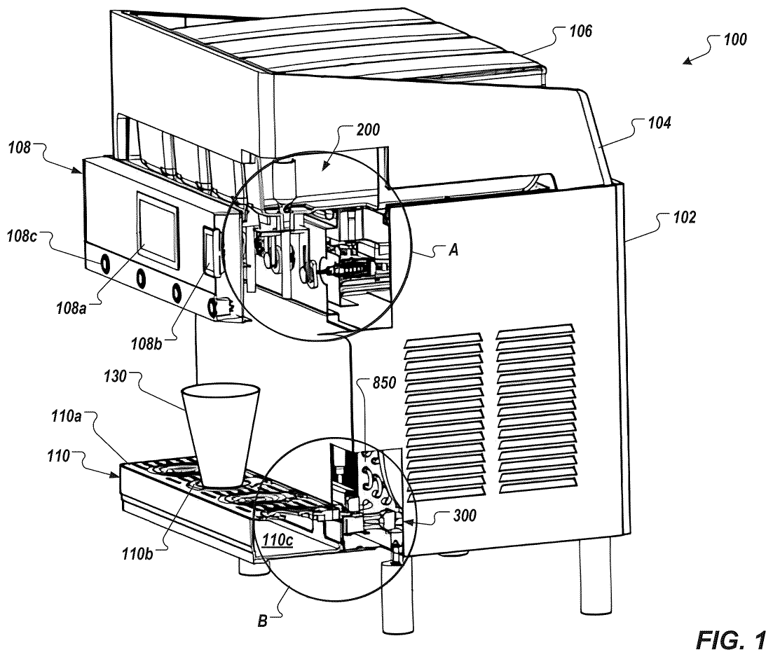

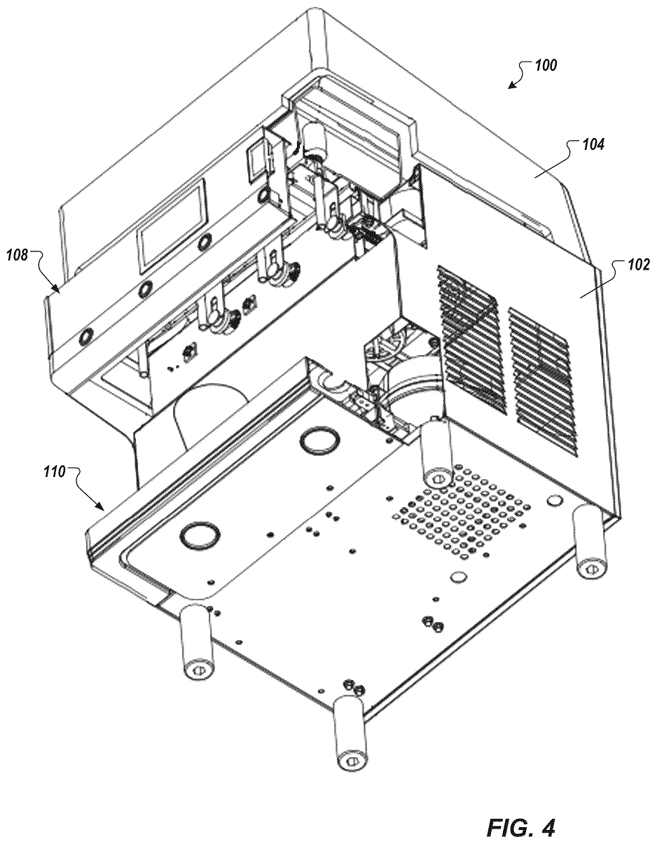

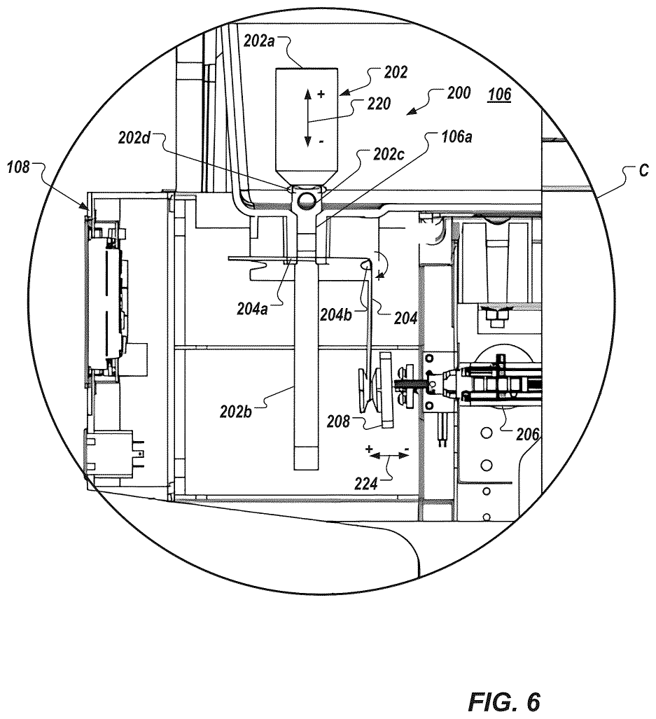

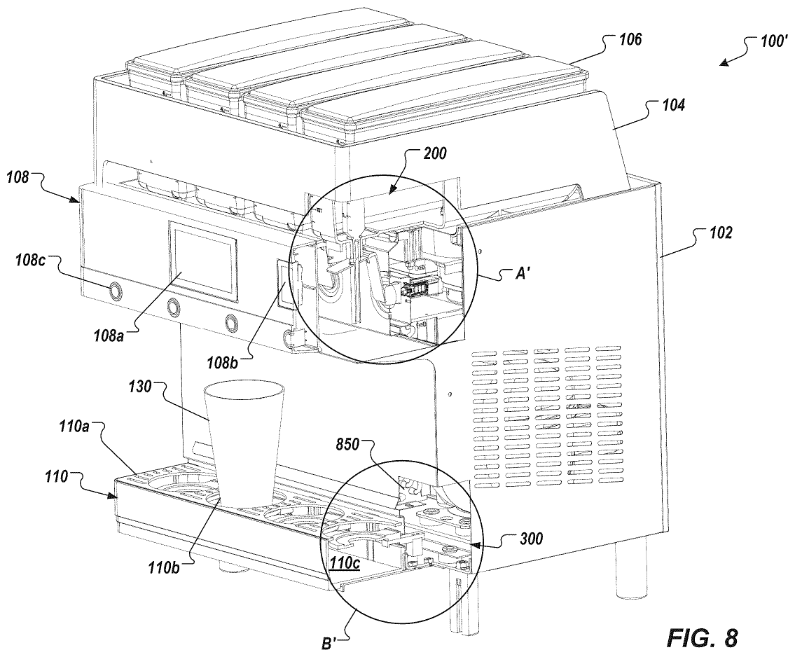

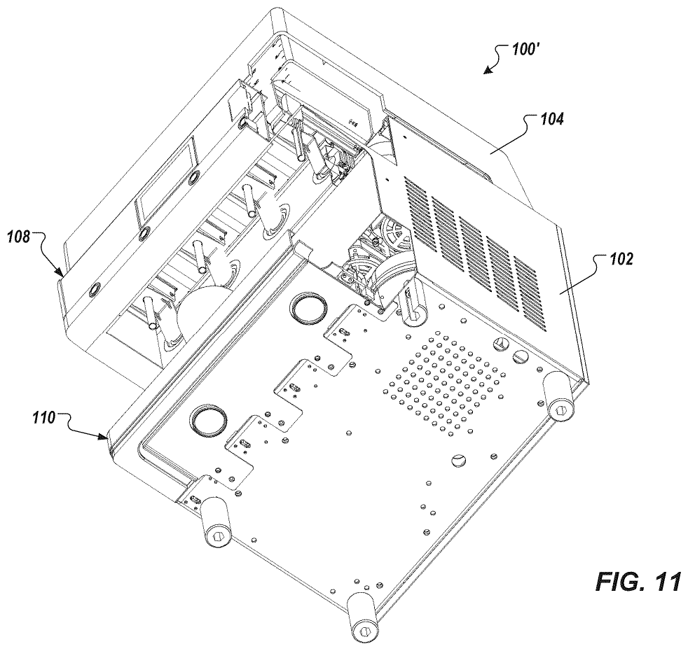

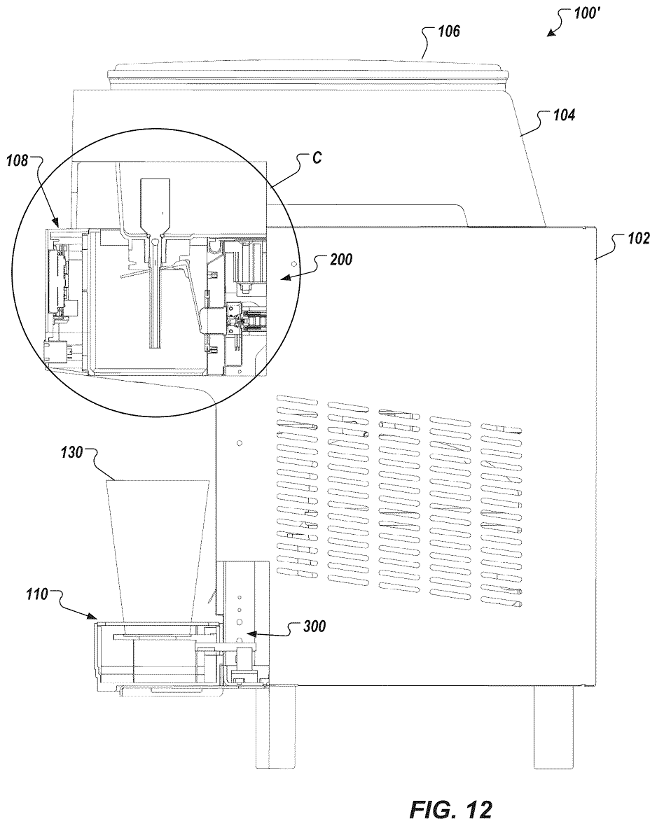

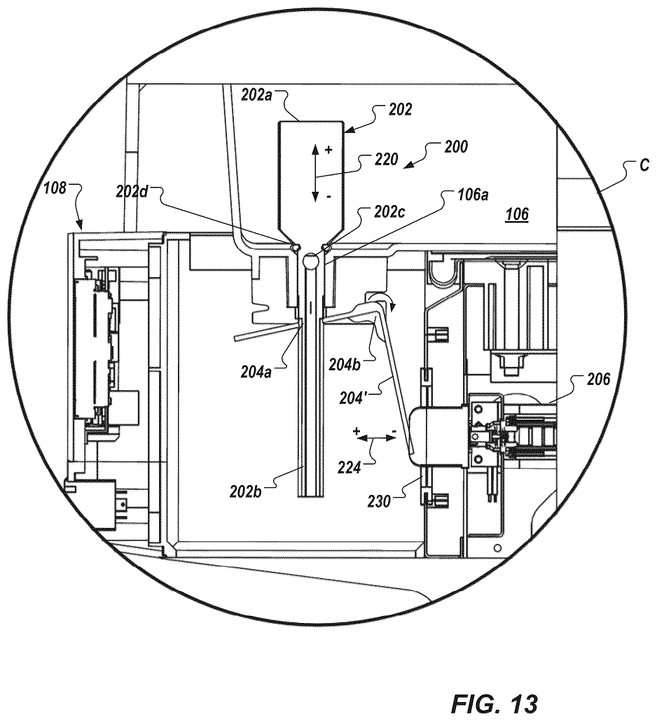

FIGS. 1-7 depict views of a beverage dispenser 100 in accordance with implementations of the present disclosure. FIGS. 8-14 depict views of a beverage dispenser 100′ in accordance with implementations of the present disclosure. Like reference numbers are used to designate like components between the beverage dispenser 100 and the beverage dispenser 100′. As described in further detail herein, the beverage dispenser 100 and the beverage dispenser 100′ each enables automatic dispensing of beverages and/or beverage ingredients with precise quantity control. Example beverages can include, but are not limited to, liquid beverages such as coffee, juice, and water.

FIGS. 1 and 8 depict top perspective views of the beverage dispenser 100 and the beverage dispenser 100′, respectively, in accordance with implementations of the present disclosure. As depicted in FIGS. 1 and 8, the beverage dispenser 100, 100′ includes a housing 102, a shield 104, reservoirs 106, a control unit 108, and a support unit 110. The housing 102 supports the reservoirs 106, the control unit 108, and the support unit 110. Although four reservoirs 106 are depicted in FIGS. 1 and 8, it is contemplated that the beverage dispensers 100, 100′ can be realized using any appropriate number of reservoirs 106.

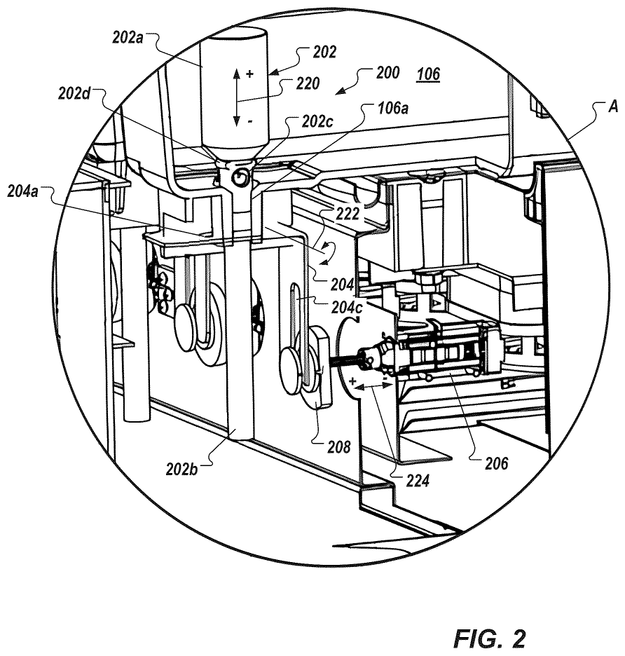

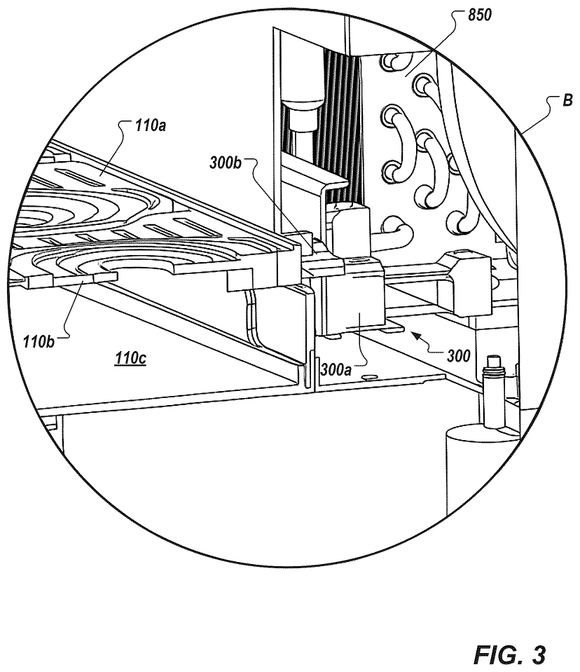

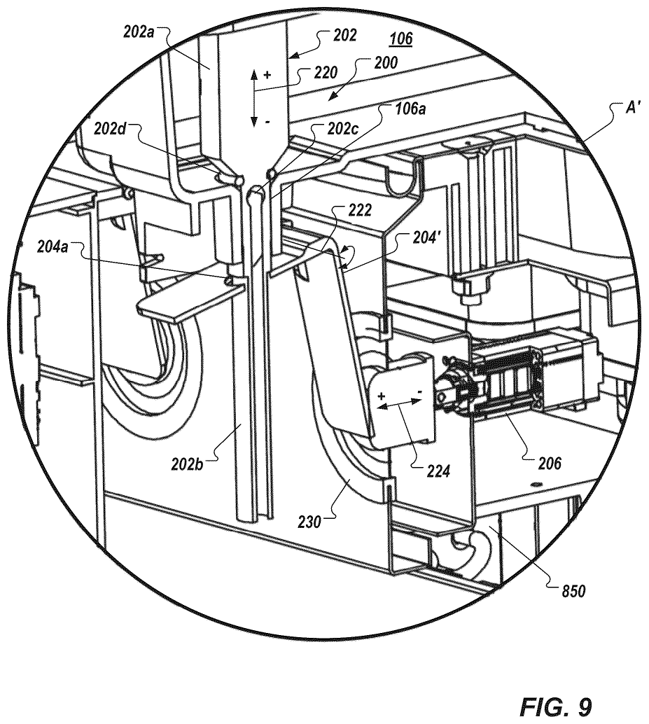

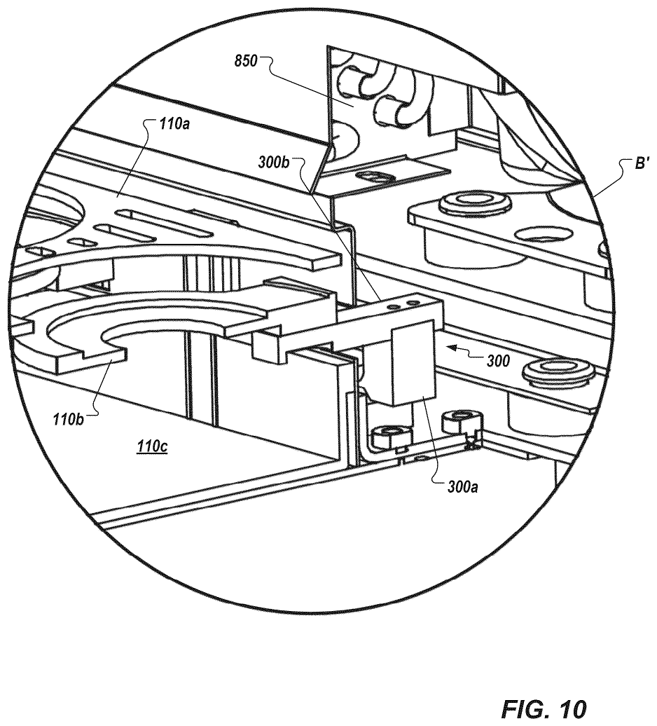

The examples of FIGS. 1 and 8 include a cutout portion A, A′ to detail a dispensing system 200, described in further detail herein with reference to FIGS. 2 and 9, and a cutout portion B, B′ to detail a weighing system 300, described in further detail herein with reference to FIGS. 3 and 10. With continued reference to FIGS. 1 and 8, the control unit 108 includes a control panel 108a (e.g., LED screen), a scanner 108b, and buttons 108c. The support unit 110 includes a grill 110a, weighing trays 110b, and a channel 110c. As described in further detail herein, the beverage dispenser 100 is operable to dispense liquids (e.g., beverages, beverage ingredients) from each of the reservoirs 106, whereby an amount of a liquid dispensed is automatically controlled by the dispensing system 200 responsive to signals provided by the weighing system 300.

In some examples, the control unit 108 includes one or more processors and computer-readable memory. For example, the one or more processors are operable to execute one or more computer programs to enable the beverage dispenser 100 to perform functionality, such as functionality described herein, the one or more computer programs being stored in the computer-readable memory. In some examples, the control unit 108 includes one or more communication components that enable communication with one or more devices (e.g., remote servers). Example communication components can include wired and/or wireless communication components (e.g., Ethernet, RJ-45, WiFi, Bluetooth, near-field communication (NFC)).

FIGS. 2 and 9 depict an enlarged view of the cutout portions A, A′ depicted in FIGS. 1 and 8, respectively. As noted above, FIGS. 2 and 9 depict a dispensing system 200. Although details of one dispensing system 200 are provided herein, it is contemplated that each of the reservoirs 106 is associated with a respective dispensing system 200.

As depicted in FIGS. 2 and 9, the dispensing system 200 includes a weighted valve 202, a dispensing lever 204, 204′, an actuator 206 (e.g., a hybrid stepping motor, an electric lead screw, a solenoid), and a coupling 208 (FIG. 2). In some examples, a component of the actuator 206 extends or contracts to act on the dispensing lever 204, 204′. For example, a lead screw of the actuator 206 can move along a linear axis 224 in steps, each step defining a distance of linear movement (e.g., 0.005 mm per step). In some examples, the weighted valve 202 includes a weighted head 202a, a dispensing tube 202b, one or more dispensing ports 202c, and a sealing ring 202d. The dispensing tube 202b is received through a through port 106a of the reservoir 106 and a hole 204a of the dispensing lever 204. In the examples of FIGS. 2 and 9, the weighted head 202a has a larger diameter than the dispensing tube 202b, such that a step is formed to limit movement of the weighted valve 202 along a linear axis 220.

As described in further detail herein, the weighted valve 202 is movable along the linear axis 220 between a closed position, in which fluid flow through the weighted valve 202 is prevented, and an opened position, in which fluid flow through the weighted valve 202 is enabled. As depicted in FIG. 2, the weighted valve 202 is in the opened position, in which the weighted head 202a and one or more dispensing ports 202c are all located below 106a. As depicted in FIG. 9, the weighted valve 202 is in the closed position, in which the weighted head 202a and one or more dispensing ports 202c are located on both sides of 106a.

In further detail, and as noted above, the reservoir 106 is provided with the through port 106a at the bottom. In the closed position, fluid flow through the weighted valve 202 is blocked by the through port 106a. More particularly, a discharge channel is provided in the dispensing tube 202b of the weighted valve 202 that is in fluid communication with the one or more dispensing ports 202c. For example, the weighted valve 202 can include a first dispensing port 202c and a second dispensing port 202c that are spaced apart from each other (e.g., on opposite sides of the weighted valve 202). In some examples, the first dispensing port 202c and the second dispensing port 202c are formed by drilling through the weighted valve 202. Having multiple dispensing ports 202c provides an increased flow rate through the weighted valve 202 relative to a single dispensing port 202c.

The dispensing lever 204, 204′ is rotatable about an axis 222 to move the weighted valve 202 to the opened position. The actuator 206 operates along the linear axis 224 to act on the dispensing lever 204, 204′ and induce rotation of the dispensing lever 204, 204′ against the weight of the weighted valve 202. For example, operating along the linear axis 224 in the positive (+) direction, the actuator 206 induces rotation of the dispensing lever 204, 204′ about the axis 222 to drive the weighted valve 202 upward within the through port 106a along the linear axis 220 in the positive direction (+) to the opened position. In the opened position, the dispensing port(s) 202c are exposed to the interior of the reservoir 106, as depicted in FIG. 2. This enables fluid to flow through the dispensing port(s) 202c into and through the dispensing tube 202b.

In the opened position, when the dispensing port(s) 202c is exposed above the through port 106a, the liquid enters the dispensing tube 202b through the dispensing port(s) 202c, which results in a negative pressure being formed to induce continuous suction of the liquid through the dispensing port(s) 202c into the dispensing tube 202b. That is, the liquid is continuously sucked into the weighted valve 202 by the negative pressure, such that leakage of the liquid between the dispensing tube 202b and through the through port 106a is mitigated. More particularly, the through port 106a defines an enclosing wall that the dispensing tube 202b is inserted through. It can be noted that the dispensing tube 202b is in contact with the enclosing wall, such that, when the dispensing post(s) 202c is/are exposed above the through port 106, the liquid enters the dispensing tube 202b through the dispensing port(s) 202c, forming the negative pressure and continuous suction described above, which inhibits leakage of the liquid from between the dispensing tube 202b and the enclosing wall of the through port 106a. In some examples, the dispensing tube 202b has a low tolerance fit with enclosing wall of the through port 106a to inhibit leakage of the liquid. In some examples, an additional sealing ring can be provided below the dispensing port(s) 202c to inhibit leakage when the weighted valve 202 is in the opened position

After an amount of fluid has been dispensed through the weighted valve 202, the actuator 206 operates along the linear axis 224 in the negative (−) direction to relieve force that the actuator 206 had applied to the dispensing lever 204, 204′. The weighted valve 202 falls downward (due to gravity) within the through port 106a to the closed position, inducing rotation of the dispensing lever 204, 204′ about the axis 222. In the closed position, the dispensing port(s) 202c are blocked from the interior of the reservoir 106 to prevent fluid flow through the weighted valve 202, as depicted in FIG. 9. Further, the sealing ring 202d provides a seal between the weighted valve 202 and the reservoir 106 to inhibit leakage of fluid (e.g., through the through port 106a). More particularly, the weight of the weighted valve 202 presses the sealing ring 202d against an interior of the reservoir 106 to provide the seal.

When in use to dispense liquid from one of the reservoirs, a machine-readable code (e.g., a QR code, a barcode) can be generated that encodes information regarding liquid that is to be dispensed. Example information can include one or more of a recipe (e.g., an identifier uniquely identifying a recipe for a beverage among a plurality of recipes), a reservoir that is to be used to dispense the liquid, a type of the liquid, and a target amount (e.g., volume such as milliliters, weight such as fluid ounces) of the liquid. For example, the machine-readable code can be printed on a label that is affixed to a container 130, depicted in FIGS. 1 and 9, such as a cup. The container 130 can be presented in front of the scanner 108b, which reads the information from the machine-readable code. In this manner, the control unit 108 can determine or is informed of the reservoir 106 that is to be used to dispense the liquid and the target amount of the liquid that is to be dispensed.

In some examples, a recipe can include multiple, different liquids that are to be dispensed from respective reservoirs 106 at respective target amounts. For example, a recipe can include a first liquid at a first target amount and a second liquid at a second target amount. In some examples, the first liquid can be dispensed by operating an actuator of a respective dispensing system 200 to move its weighted valve 202 from the closed position to the opened position to dispense amounts of the first liquid through to the first target amount, as described herein. After ceasing dispensing of the first liquid, the second liquid can be dispensed by operating an actuator of a respective dispensing system 200 to move its weighted valve 202 from the closed position to the opened position to dispense amounts of the second liquid through to the second target amount, as described herein. However, if a certain liquid is popular, two or more reservoirs 106 may contain the same liquid.

An operator can place the container 130 on the weighing tray 110b of the respective reservoir 106. For example, a button 108c of the control unit 108 can provide an indication (e.g., a light that illuminates) as to which reservoir 106 that the liquid is to be dispensed from and the container 130 can be placed on the weighing tray 110b of the indicated reservoir 106. Placement of the container 130 on the weighing tray 110b can be detected by the weighing system 300, as described in further detail herein. In response, the actuator 206 operates to control lifting of the weighted valve 202 to the opened position, as described herein, in which the dispensing outlet(s) 202c are exposed to the interior of the reservoir 106 and enable the liquid to flow through the weighted valve 202 into the container 130.

As described in further detail herein, the weighing system 300 can monitor a weight of the container 130 and liquid during dispensing of the liquid. When the weight weighed by the weighing system 300 reaches a predetermined weight, the actuator 206 operates to enable the weighted valve 202 to descend to the closed position, as described herein. The predetermined weight is provided from the information from the machine-readable code. For example, the predetermined weight is provided from the amount of the liquid as encoded in the machine-readable code. Accordingly, the beverage dispenser 100 functions automatically to dispense a precise amount of a beverage and mitigates opportunities for error on the part of the operator. For example, and as described above, the beverage dispenser 100 indicates, which reservoir 106 is to be used to dispense the liquid and only operates to dispense the liquid in response to the container 130 being placed on the respective weighing tray 110b.

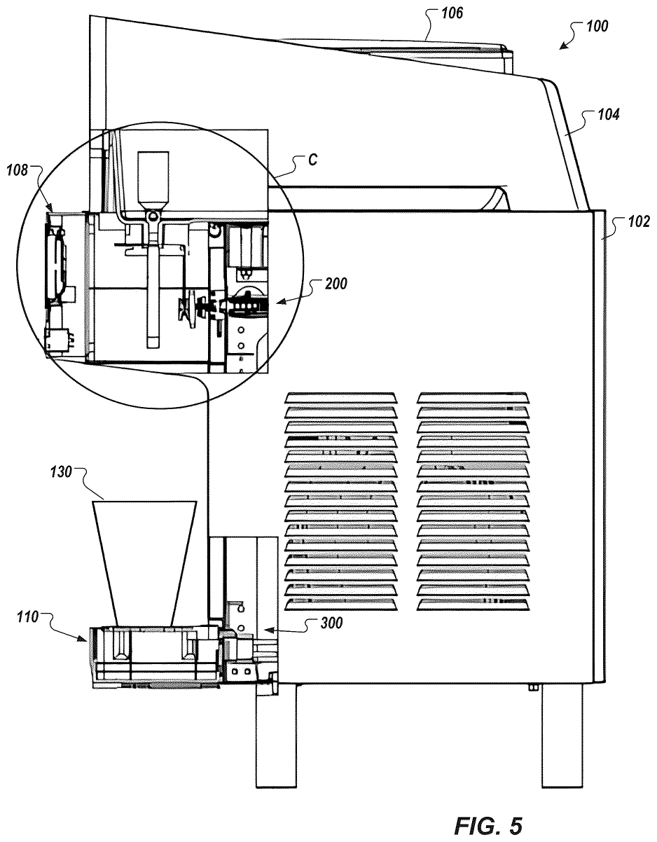

As depicted in FIGS. 5, 6, 12, and 13, in some examples, and in order to reasonably utilize space, the actuator 206 can be arranged within the housing 102 located below a respective reservoir 106 and connected to the control unit 108. The driving direction of the actuator 206, along the linear axis 224, can be perpendicular to the lifting direction of the weighted valve 202 along the linear axis 220. This avoids the actuator 206 from being arranged below the weighted valve 202 and avoids interference with the dispensing of the liquid out of the dispensing tube 202b. In order to adapt to the driving direction of the actuator 206, the dispensing lever 204, 204′ is L-shaped and is rotatably supported by a shaft 204b to rotate about the axis 222. As described herein, the actuator 206 drives a first end of the dispensing lever 204 to move, such that a second end of the dispensing lever 204 drives the weighted valve 202 to rise. In some examples, the actuator 206 can be provided as, but is not limited to, an electric push rod, such as a solenoid, or as a motor, such as a hybrid stepping motor. In some examples, the coupling 208 of FIG. 2 couples the actuator 206 to the dispensing lever 204.

With particular to FIG. 2, in the depicted example, the first end of the dispensing lever 204 is provided with a slot 204c and a driving end of the actuator 206 is engaged with the coupling 208, which is engaged with the slot 204c. The coupling 208 has two limiting members at intervals along the driving direction and the dispensing lever 204 is located between the two limiting members so as to be able to drive the first end of the dispensing lever 204 to move. The two limiting members can be, but are not limited to, being sleeved on a push rod of the actuator 206, so as to facilitate disassembly of the dispensing lever 204.

With reference to FIGS. 2 and 9, the second end of the dispensing lever 204, 204′ is provided with the hole 204a. The second end of the dispensing lever 204, 204′ is sleeved on the dispensing tube 202b through the hole 204a, so that the dispensing lever 204, 204′ is abutted against a step of the weighted valve 202. When the actuator 206 extends to drive the first end of the dispensing lever 204 to move, the second end of the dispensing lever 204, 204′ rises and abuts against the step to push the weighted valve 202 upwards. When the actuator 206 contracts, the weight of the weighted valve 202 induces movement of the weighted valve 202 downward and drives the second end of the dispensing lever 204, 204′. In some examples, extension and/or contraction of the actuator 206 is provided as step movement, as discussed above (e.g., linear movement at 0.005 mm per step).

In the example of FIG. 9, the dispensing system 200 of the beverage dispenser 100′ includes a boot 230 that is disposed between a dispensing lever 204′ and the actuator 206. As depicted in FIG. 9, the boot 230 is mounted within an opening of the housing 102 preventing ingress/egress of material to/from an interior of the housing 102. In this manner, material that could dirty or damage components located within the housing 102 is prevented from entering the housing 102. For example, liquid from splashing is prevented from entering the housing 102 and coming into contact with the actuator 206. In the example of FIG. 9, when the actuator 206 operates to move along the linear axis 224 in the positive (+) direction, the actuator 206 pushes on the dispensing lever 204′ through the boot 230. In some examples, the boot 230 includes folds that enable flexing of the boot 230. In this manner, the boot 230 does not impede movement of the actuator 206. As noted, as depicted in FIG. 9, the weighted valve 202 is in the closed position, in which liquid is prevented from flowing through the weighted valve 202.

As depicted in FIGS. 3 and 10, and in some examples, the weighing system 300 includes a respective weighing tray 110b and a weighing sensor 300a. In some examples, the weighing tray 110b is mechanically coupled to the weighing sensor 300a by a coupling 300b. The weighing sensor 300a generates signals responsive to weight applied to the weighing tray 110b and is in communication with the control unit 108. In some examples, the control unit 108 receives the signals from the weighing sensor 300a that indicate a weight placed on the weighing tray 110b. In some examples, the weight of the container 130 and any liquid in the container 130 placed on the weighing tray 110b can be collectively determined. The weight can reflect the amount of liquid contained within the container 130, for example, by subtracting the gross weight of the container 130. As described in further detail herein, when the signal indicates that the target amount has been achieved, dispensing of the liquid is ceased (i.e., the weighted valve 202 moves to the closed position).

In some implementations, for each liquid that is dispensed and for each instance of dispensing, historical data is recorded. Example historical data can include, but is not limited to, a target amount, an actual amount, and a dispensing time. In some examples, for each liquid, the dispensing time required to dispense the liquid can be monitored. The historical data can be used to operate the beverage dispenser 100, as described in further detail herein.

As introduced above, the support unit 110 of the beverage dispenser 100 includes the channel 110c. In some examples, the channel 110c is independently detachable from the housing 102 (e.g., snap connection, plug connection, screw connection) and is provided as a hollow structure to enable fluid flow therethrough. In some examples, an upper end surface of the channel 110c is provided with an inlay, such as the grill 110a, and the weighing trays 110b are arranged at the inlay. In some examples, the grill 110a includes leak holes that enable liquid to flow therethrough into the channel 110c, so that excess liquids generated by accidental factors, such as splashing, can be collected.

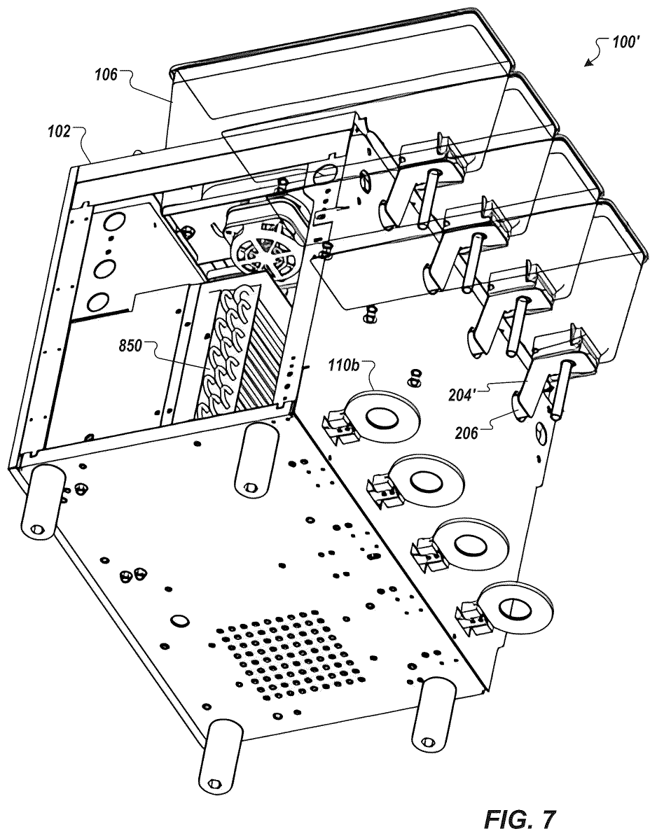

With particular reference to FIGS. 7, 8, 9, and 11-14, the dispensing lever 204′ is depicted as an alternative to the dispensing lever 204 described herein. Here, the dispensing lever 204′ is absent the slot 204c discussed above with reference to FIG. 2. In the depicted examples, the actuator 206 pushes against the first end of the dispensing lever 204′ to actuate the dispensing lever 204′ as described herein. The arrangement depicted in FIGS. 7, 8, 9, and 11-14 with the dispensing lever 204′, obviates the need for the coupling 208.

As discussed above, liquid can be automatically dispensed into a container, such as the container 130, in response to detecting placement of the container on a respective weighing tray 110b. It can occur, however, that the container is too large to fit into the beverage dispenser 100 for placement on a respective weighing tray 110b. In such a scenario, the container is not placeable on a respective weighing tray 110b to trigger automatic dispensing of the liquid. In view of this, the operator can place the container, such that the dispensing tube 202b is positioned over or within the container and can manually press the respective button 108c (i.e., the button 108c that provides the indication, as to which liquid is to be dispensed). In some examples, when to cease dispensing of the liquid is determined using historical flow rate data (e.g., prior dispensing weights/dispensing durations) to estimate the required dispensing time for the target weight of the liquid. In some examples, using the historical flow rate data, an estimated dispensing time can be determined and dispensing automatically ceases when the estimated dispending time elapses.

In some examples, the estimated dispensing time is determined based on historical data for the liquid. For example, historical data for the liquid can be retrieved (e.g., from computer-readable memory) and the estimated dispensing time can be determined as an average dispensing time of the dispensing times recorded in the historical data for the given target amount. In some examples, anomalies can occur in dispensing liquids (e.g., due to operator error, such as bumping the container during dispensing), which can be filtered from being recorded as historical data (e.g., if a dispensing time differs from an estimated dispensing time by a threshold difference, the dispensing time is filtered from the historical data or is at least filtered from being used to update the estimated dispensing time).

By way of non-limiting example, the following historical data can be recorded for a liquid L₁:

TABLE 1
Example Historical Data
L₁

| | Historical | Historical | Estimated |
|---|---|---|---|
| Target | Dispensing | Actual | Dispensing |
| Amount | Times | Amounts | Time |
| A_{T1} | [t_{act1}, . . . , t_{actm}]₁ | [A_{act1}, . . . , A_{actm}]₁ | tₑₛₜ₁ |
| A_{T2} | [t_{act1}, . . . , t_{actn}]₂ | [A_{act1}, . . . , A_{actn}]₂ | tₑₛₜ₂ |
| A_{T3} | [t_{act1}, . . . , t_{actp}]₃ | [A_{act1}, . . . , A_{actp}]₃ | tₑₛₜ₃ |

In the example of Table 1, A_{T1}, A_{T2}, and A_{T3} indicate respective amounts of a liquid per a recipe (e.g., small, medium, large), [t_{act1}, . . . , t_{actm}]₁, are actual dispensing times to dispense the liquid for multiple instances of dispensing A_{T1} (e.g., dispensed m times), tₑₛₜ₁ is the estimated dispensing time to dispense A_{T1} (e.g., determined as the average of [t_{act1}, . . . , t_{actm}]₁), [t_{act1}, . . . , t_{actm}]₂, are actual dispensing times to dispense the liquid for multiple instances of dispensing A_{T2} (e.g., dispensed n times), tₑₛₜ₂ is the estimated dispensing time to dispense A_{T2} (e.g., determined as the average of [t_{act1}, . . . , t_{actm}]₂), and [t_{act1}, . . . , t_{actm}]₃, are actual dispensing times to dispense the liquid for multiple instances of dispensing A_{T3} (e.g., dispensed p times), tₑₛₜ₃ is the estimated dispensing time to dispense A_{T3} (e.g., determined as the average of [t_{act1}, . . . , t_{actm}]₃).

In some implementations, the actual amount can be monitored over time to determine whether the actual amount differs from the target amount over time. For example, an average actual amount can be determined from the historical data (e.g., the average of [A_{act1}, . . . , A_{actm}]₁) and can be compared to the target amount. If a difference between the actual amount and the target amount by a threshold difference (e.g., ≥5%), a correction can be made. In some examples, if the actual amount is greater than the target, an example correction can be to increase the offset (e.g., from 3 g to 5 g) to cease dispensing of the liquid earlier (e.g., when the signal indicates 295 g has been dispensed). If the actual amount is less than the target amount, an example correction can be to a sensor offset of the weighing sensor 300a.

In some scenarios, environmental factors and/or components of the beverage dispenser 100 can affect the weighing system 300 in determining an amount of a liquid that has been dispensed. For example, vibrations can occur (e.g., due to compressor operation, condenser fan activity, liquid impact within the container) that can affect the weighing system 300 in its operations. In some examples, the effects of such factors can be mitigated. For example, data encoded in the signal of the weighing sensor 300a can be continuously sampled (e.g., by the control unit 108) over a period (e.g., 40 milliseconds), capturing both background vibrations and superimposed actual weight of the liquid dispensed into the container. Through frequency and amplitude analysis and filtering algorithms (e.g., proportional-integral-derivative (PID) control), weight fluctuations due to external factors can be removed to provide accurate amount data.

In dispensing liquid to achieve a target amount, it can be noted that there is residual drip of the liquid immediately after the weighted valve 202 moves to the closed position. That is, as the weighted valve 202 moves to the closed position and the dispensing port(s) 202c is/are blocked in response to the signal of the weighing sensor 300a, a residual amount of the liquid is in the dispensing tube 202b that falls into the container after dispensing is technically ceased. In view of this, the dispensing system 200 is controlled to determine timing for moving the weighted valve 202 to the closed position before the target amount is achieved within the container.

In further detail, and for purposes of non-limiting illustration, example values are used and can include a target amount of 300 g is determined for the liquid. Dispensing of the liquid commences and the weighing system 300 monitors an amount of liquid dispensed. When the amount of liquid achieves 297 g, dispensing of the liquid ceases with the expectation of a residual drip of 3 g of the liquid from the dispensing tube 202b. Here, the residual drip is provided as a predefined offset that can be programmed into the beverage dispenser 100.

In some implementations, dispensing of the liquid can be wholly manual. For example, it can occur that one or more functionalities of the beverage dispenser 100 are inoperable, such that automatic dispensing is disabled. In such instances, the operator can manually dispense the liquid by, for example, pressing the button 108c to initiate dispensing and releasing the button 108c to cease dispensing.

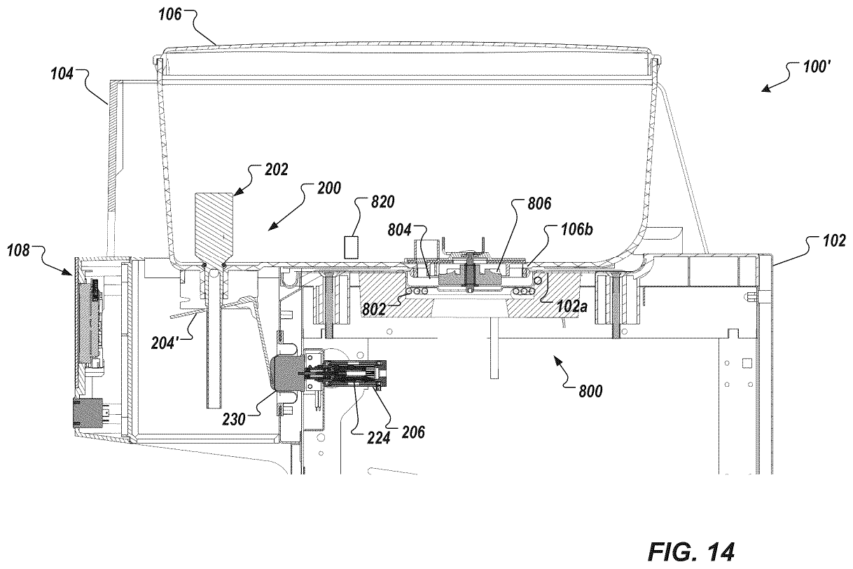

FIG. 14 depicts a cross-sectional view of the beverage dispenser 100′ in accordance with implementations of the present disclosure. As depicted in FIG. 14, the beverage dispenser 100 includes a cooling system 800 that enables cooling of the liquid contained in the reservoir 106. The beverage dispenser 100 of FIGS. 1 to 6 can also include the cooling system 800. It is contemplated that each reservoir 106 has a cooling system 800 associated therewith. In the example of FIG. 14, the cooling system 800 includes cooling tubes 802 that are in heat exchange contact with an upper surface 102a of the housing 102. In some examples, a cooling fluid (e.g., a refrigerant) flows through the cooling tubes 802. The cooling fluid is provided through a refrigeration system contained within the housing 102. Although not depicted in FIG. 8, portions of the refrigeration system are depicted in FIGS. 1, 3, and 7-10. An example portion of the refrigeration system includes a heat exchanger 850 (e.g., an evaporator, a condenser).

With continued reference to FIG. 14, the reservoir 106 includes an opening 106b. In some examples, the opening 106b and the upper surface 102a collectively at least partially define a cooling chamber 804. In some examples, liquid can flow into and out of the cooling chamber 804. While in the cooling chamber 804, the liquid is in heat exchange contact with the upper surface 102a to enable cooling of the liquid by the cooling fluid flowing through the cooling tubes 802.

In some examples, the cooling system 800 includes a stirrer 806 that operates to stir the liquid to pull liquid into and drive liquid from the cooling chamber 804. In this manner, the stirrer 806 is operable to maintain a consistent (homogonous) temperature of the liquid within the reservoir 106. The stirrer 806 can be driven by a motor (not shown). For example, the stirrer 806 can be in magnetic communication with the motor through the upper surface 102a. In this manner, the cooling chamber 804 is sealed from the interior of the housing 102.

In some examples, a temperature sensor 820 is provided and is responsive to a temperature of the liquid within the reservoir 106. It is contemplated that each reservoir 106 has a temperature sensor 820 associated therewith. In some examples, the temperature sensor 820 is in communication with the control unit 108, which monitors temperatures of liquids in each of the reservoirs 106. In some examples, if a temperature of a liquid within a reservoir 106 exceeds a threshold temperature difference (e.g., a difference between a target temperature and an actual temperature), the refrigeration system and cooling system 800 of the respective reservoir are activated to cool the liquid toward the target temperature. In this manner, cooling of the liquids in the respective reservoirs 106 is independently controllable.

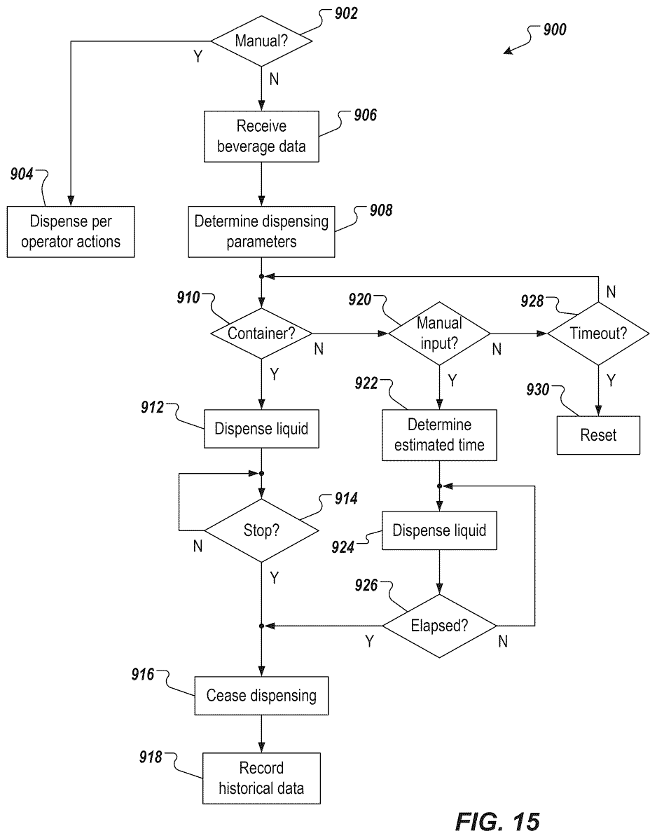

FIG. 15 depicts an example process 900 that can be executed in accordance with implementations of the present disclosure. In some examples, the example process 900 is provided using one or more computer-executable programs executed by one or more processors (e.g., of the control unit 108).

It is determined whether manual operation is to be performed (902). For example, and as described in detail herein, the beverage dispenser 100 can operate in a manual mode. If it is determined that manual operation is to be performed, liquid is dispensed per operator actions (904). For example, and as described in detail herein, the operator can press a button 108c of a respective reservoir 106 to commence dispensing of the liquid and releases the button 108c to cease dispensing of the liquid.

If manual operation is not to be performed, beverage data is received (906). For example, and as described in detail herein with reference to FIG. 1, the scanner 108b of the beverage dispenser 100 scans a machine-readable code associated with a container, such as the container 130. In some examples, the machine-readable code encodes the beverage data. In some examples, the machine-readable code encodes an identifier (e.g., uniquely identifying a recipe) that is used to look-up the beverage data from computer-readable memory. In some examples, the beverage data includes a type of liquid and a target amount of liquid. In some examples, the type of liquid can be used to identify a particular reservoir 106, from which the liquid is to be dispensed. For example, each reservoir can be mapped to a type of liquid in a computer-readable mapping stored in computer-readable memory. The computer-readable mapping can be indexed with the type of liquid provided in the beverage data to determine the reservoir 106, from which the liquid is to be dispensed. Dispensing parameters are determined (908). For example, and as described in detail herein, a reservoir that is to be used to dispense the liquid to the target amount can be determined. In some examples, an indicator (e.g., a light of a button 108c) can be provided to indicate the reservoir that is to be used to dispense the liquid to the target amount.

It is determined whether a container has been placed for dispensing (910). For example, and as described in detail herein, an operator can place a container on a weighing tray 110c. If the container is placed on the weighing tray 110c that corresponds to the reservoir 106 that is to be used to dispense the liquid, it is determined that a container has been placed for dispensing. If the container is not placed on the weighing tray 110c that corresponds to the reservoir 106 that is to be used to dispense the liquid, it is determined that a container has not been placed for dispensing.

If it is determined that a container has been placed for dispensing, dispensing of the liquid commences (912). For example, and as described in detail herein, the dispensing system 200 associated with the reservoir operates to move the weighted valve 202 to the opened position to enable flow of the liquid through the weighted valve 202. It is determined whether a stop amount of the liquid has been achieved (914). For example, and as described in detail herein, a stop amount of the liquid can be determined as a difference between the target amount and an offset. In some examples, the weighing system monitors amounts of the liquid dispensed into the container to determine whether the stop amount of the liquid has been achieved. If the stop amount has not been achieved, dispensing of the liquid continues. If the stop amount has been achieved, dispensing of the liquid is ceased (916) and historical data is recorded (918). For example, and as described in detail herein, the dispensing system 200 associated with the reservoir operates to move the weighted valve 202 to the closed position to block flow of the liquid through the weighted valve 202.

If it is determined that a container has not been placed for dispensing, it is determined whether manual input has been received (920). For example, it can be determined that a button 108c associated with the reservoir 106 that is to dispense the liquid has been pressed. If manual input has been received, an estimated dispensing time is determined (922) and dispensing of the liquid commences (924). For example, and as described in detail herein, an estimated dispensing time is determined from historical data and the dispensing system 200 associated with the reservoir operates to move the weighted valve 202 to the opened position to enable flow of the liquid through the weighted valve 202. It is determined whether the estimated time has elapsed (926). For example, a time difference between a current time and a time at which dispensing started is determined and is compared to the estimated dispensing time. If the time difference is less than the estimated dispensing time, the estimated dispensing time has not elapsed. If the estimated dispensing time has not elapsed, dispensing of the liquid continues. If the estimated time has elapsed, dispensing of the liquid is ceased (916) and historical data is recorded (918).

If it is determined that manual input has not been received, it is determined whether a timeout period has elapsed (928). For example, a timeout time is determined as a difference between a current time and a time at which the machine-readable code was read by the scanner 108b. The timeout time is compared to the timeout period. If the timeout time is less than the timeout period, the timeout period has not elapsed. If the timeout period has not elapsed, the example process 900 loops back. If the timeout period has elapsed, a reset is performed (930). For example, the beverage dispenser 100 clears data read from the machine-readable code and is ready to read data from another machine-readable code.

Features described herein can be implemented in digital electronic circuitry, or in computer hardware, firmware, software, or in combinations of thereof. Method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A beverage dispenser, comprising:
a first reservoir containing a first liquid;
a first dispensing system associated with the first reservoir, the first dispensing system comprising a weighted valve, a dispensing lever, and an actuator; and
a control unit comprising a scanner operable to scan machine-readable codes, the control unit being operable to execute instructions stored in computer-readable memory to perform operations responsive to data determined from a machine-readable code, the operations comprising:
operating the actuator for movement of the dispensing lever to one or more of move the weighted valve from a closed position to an opened position to dispense amounts of the first liquid through the weighted valve, and move the weighted valve from an opened position to a closed position to cease dispensing of the first liquid.

2. The beverage dispenser of claim 1, wherein the operations further comprise:
monitoring dispensing of amounts of the first liquid from the first reservoir; and
determining that one of an actual amount of the first liquid dispensed from the first reservoir has achieved a stop amount and an estimated dispensing time has been met, and in response, operating the actuator of the first dispensing system for movement of the dispensing lever to move the weighted valve to a closed position to cease dispensing of the first liquid from the first reservoir.

3. The beverage dispenser of claim 2, further comprising a weighing system comprising a weighing sensor that generates a weight signal responsive to dispensing of the first liquid, the actual amount being determined based on the weight signal.

4. The beverage dispenser of claim 2, wherein the stop amount is determined as a difference between a target amount and an offset amount.

5. The beverage dispenser of claim 4, wherein the target amount is determined from the data determined from the machine-readable code.

6. The beverage dispenser of claim 1, wherein the operations further comprise one of:
determining that a container has been placed to receive the first liquid dispensed from the first reservoir and, in response, actuating the actuator to commence dispensing of the first liquid from the first reservoir; and
determining that a button associated with the first reservoir has been pressed and, in response, actuating the actuator to commence dispensing of the first liquid from the first reservoir.

7. The beverage dispenser of claim 1, wherein operations further comprise actuating the actuator to push a first end of the dispensing lever away from a housing of the beverage dispenser to move a second end of the dispensing lever against the weighted valve to move the weighted valve to the opened position.

8. The beverage dispenser of claim 1, wherein the operations further comprise activating an indicator to indicate the first reservoir as to be used to dispense the first liquid from among a plurality of reservoirs.

9. The beverage dispenser of claim 1, further comprising a second reservoir containing a second liquid and a second dispensing system associated with the second reservoir, wherein operations further comprise determining from second data determined from a second machine-readable code that a second liquid is to be dispensed from the second reservoir and, in response, activating an indicator to indicate the second reservoir as to be used to dispense the second liquid from among a plurality of reservoirs.

10. A beverage dispenser, comprising:
a plurality of reservoirs comprising a first reservoir containing a first liquid and a second reservoir containing a second liquid;
a plurality of dispensing systems comprising a first dispensing system associated with the first reservoir and a second dispensing system associated with the second reservoir; and
a control unit comprising a scanner operable to scan machine-readable codes, the control unit being operable to execute instructions stored in computer-readable memory to perform operations responsive to first data determined from a first machine-readable code, the operations comprising:
operating a first actuator of the first dispensing system to move a first weighted valve from a closed position to an opened position to dispense amounts of the first liquid through the first weighted valve, and
after ceasing dispensing of the first liquid, operating a second actuator of the second dispensing system to move a second weighted valve from the closed position to the opened position to dispense amounts of the second liquid through the second weighted valve.

11. The beverage dispenser of claim 10, wherein the operations further comprise:
determining, from the first data, that a first target amount of the first liquid is to be dispensed from the first reservoir;
monitoring dispensing of amounts of the first liquid from the first reservoir; and
determining that one of an actual amount of the first liquid dispensed from the first reservoir has achieved a stop amount and an estimated dispensing time has been met, and in response, operating the first actuator of the first dispensing system for movement of a dispensing lever to move the first weighted valve to the closed position to cease dispensing of the first liquid from the first reservoir.

12. The beverage dispenser of claim 10, wherein the operations further comprise determining, from the first data, that a second target amount of the second liquid is to be dispensed from the second reservoir.

13. The beverage dispenser of claim 10, wherein operations further comprise determining, from second data determined from a second machine-readable code, that a second target amount of the second liquid is to be dispensed from the second reservoir.

14. The beverage dispenser of claim 10, further comprising a weighing system comprising a weighing sensor that generates a weight signal responsive to dispensing of the first liquid, the actual amount being determined based on the weight signal.

15. The beverage dispenser of claim 10, further comprising one or more of:
a boot disposed between the first actuator and a dispensing lever that acts on the first weighted valve; and
a housing of the beverage dispenser that separates the first actuator and a dispensing lever that acts on the first weighted valve, the dispensing lever being located outside of the housing and the first actuator being located within the housing.

16. The beverage dispenser of claim 10, further comprising a cooling system that is operable to cool the first liquid within the first reservoir.

17. The beverage dispenser of claim 16, further comprising a temperature sensor that is responsive to a temperature of the first liquid within the first reservoir, the cooling system being operated responsive to the temperature.

18. The beverage dispenser of claim 10, further comprising one or more of:
a first button that is operable to manually dispense the first liquid from the first reservoir; and
a second button that is operable to manually dispense the second liquid from the second reservoir.

19. The beverage dispenser of claim 18, wherein one or more of:
the first actuator of the first dispensing system is activated in response to input to the first button; and
the second actuator of the second dispensing system is activated in response to input to the second button.

20. The beverage dispenser of claim 10, wherein operations further comprise one or more of:
activating a first indicator to indicate the first reservoir as to be used to dispense the first liquid; and
activating a second indicator to indicate the second reservoir as to be used to dispense the second liquid.
